(19) United States
(12) Patent Application Publication
(10) Pub. No.: US 2026/0249234 A1
(43) Pub. Date: Aug. 27, 2026

(54) METHOD TO REDUCE ENERGY COSTS FOR CO2 CAPTURE BY MINERAL LOOPING

(71) Applicant: UT-Battelle, LLC, Oak Ridge, TN (US)

(72) Inventors: Lawrence M. ANOVITZ, Oak Ridge, TN (US); Sai Krishna Reddy ADAPA, Oak Ridge, TN (US); Andrew G. STACK, Farragut, TN (US); Juliane WEBER, Oak Ridge, TN (US); Peng YANG, Kingston, TN (US)

(21) Appl. No.: 19/548,271

(22) Filed: Feb. 24, 2026

Related U.S. Application Data
(60) Provisional application No. 63/763,494, filed on Feb. 26, 2025.

(51) Int. Cl. B01D 53/14; B01D 53/96

(52) U.S. Cl. CPC B01D 53/1475; B01D 53/1406; B01D 53/1412; B01D 53/96; B01D 2251/402; B01D 2251/404; B01D 2251/604; B01D 2251/606; B01D 2257/504

(57) ABSTRACT

A method for capturing and releasing carbon dioxide is provided. An alkaline earth metal hydroxide is contacted with a carbon dioxide-containing gas to form a basic alkaline earth metal carbonate having carbonate and hydroxide groups and optionally water of hydration. The basic carbonate is regenerated by contacting with heated steam to yield recycled hydroxide and a regeneration off-gas comprising carbon dioxide. Regeneration may be conducted at temperatures up to 300° C., including ≤250° C., optionally in a flowing system with an inlet for steam and an outlet for off-gas. The recycled hydroxide may be re-contacted with carbon dioxide for multiple cycles. The off-gas may be cooled, dried, compressed, and/or purified for storage in a storage vessel or geological injection.

### CROSS-REFERENCE TO RELATED APPLICATIONS

This application claims the benefit of U.S. Provisional Application 63/763,494, filed on Feb. 26, 2025, the disclosures of which are incorporated by reference in their entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to the field of carbon capture and sequestration, and more specifically to a low temperature method of regenerating carbonated alkaline earth metal sorbents.

### BACKGROUND OF THE INVENTION

The concept of using minerals for carbon capture was proposed as an irreversible process in which calcium- or magnesium-bearing silicates would be mined and reacted with CO₂ in flue gas with a coal-fired power plant. The resultant carbonates would then be disposed at the surface. However, this approach is limited by the slow reaction rates of silicates with CO₂ and uncertainties regarding the availability and transport of reactive phases and products. A modified approach was developed in which calcium or magnesium oxides were used to capture CO₂. This method resulted in faster reaction rates, and a looped process was envisioned that could be created which reformed and reused the original calcium/magnesium oxides. This looped process reduced the amount of raw material needed and improved the economic efficiency of the process.

Unfortunately, this looped process resulted in efficiency reductions after multiple cycles due to sintering of calcium/magnesium oxide particles during high temperature calcining, which reduced the reactive surface area. Some studies reported up to a ~30% drop in efficiency for calcium oxides after 5 cycles depending on the calcining temperature. Other studies have indicated that magnesium oxide experiences losses ranging from 5 to 40% after 10-20 cycles. Despite the issues with sintering, magnesium oxide in particular is an especially promising sorbent for looped CO₂ capture. The energy costs of high-temperature calcining to the oxide also reduced overall efficiency.

### SUMMARY OF THE INVENTION

A method of capturing and releasing carbon dioxide is provided. The method includes the step of contacting an alkaline earth metal hydroxide with carbon dioxide to yield a basic alkaline earth metal carbonate. The basic alkaline earth metal carbonate is contacted with heated steam to yield a recycled alkaline earth metal hydroxide and a regeneration off-gas stream comprising carbon dioxide. The basic alkaline earth metal carbonate includes carbonate and hydroxide groups. The basic alkaline earth metal carbonate optionally includes water of hydration.

A method of regenerating an alkaline earth metal hydroxycarbonate is also provided. The method includes the step of contacting the alkaline earth metal hydroxycarbonate with heated steam to yield a recycled alkaline earth metal hydroxide and a regeneration off-gas stream comprising carbon dioxide. The heated steam is at a regeneration temperature of less than or equal to 250° C. The alkaline earth metal hydroxycarbonate includes magnesium, calcium or a combination thereof.

These and other features of the invention will be more fully understood and appreciated by reference to the description of the embodiments below.

### DETAILED DESCRIPTION OF THE CURRENT EMBODIMENTS

A method of capturing and releasing carbon dioxide is discussed herein. The method includes contacting an alkaline earth metal hydroxide with carbon dioxide to yield a basic alkaline earth metal carbonate. The basic alkaline earth metal carbonate is contacted with heated steam to yield a recycled alkaline earth metal hydroxide and a regeneration off-gas stream comprising carbon dioxide. The basic alkaline earth metal comprises carbonate and hydroxide groups and optionally water of hydration.

The method includes the step of contacting an alkaline earth metal hydroxide with carbon dioxide to yield a basic alkaline earth metal carbonate. As used herein, “contacting” includes bringing a carbon dioxide-containing gas phase into reactive association with the alkaline earth metal hydroxide under conditions that permit uptake of carbon dioxide and formation of carbonate and hydroxide groups within the resulting basic alkaline earth metal carbonate. In some embodiments, the alkaline earth metal hydroxide is provided as a particulate solid (e.g., powder, granules, pellets, or extrudates) and is exposed to carbon dioxide by flowing, sparging, or otherwise delivering a carbon dioxide-containing gas through or across the solid, such as in a fixed bed, moving bed, fluidized bed, or other gas-solid contacting apparatus. In other embodiments, the alkaline earth metal hydroxide is dispersed or suspended in a liquid phase (e.g., water or an aqueous medium) and carbon dioxide is introduced into the liquid (e.g., by bubbling, sparging, or agitation) to promote dissolution and reaction, after which the basic alkaline earth metal carbonate is recovered as a solid. In still other embodiments, the alkaline earth metal hydroxide is provided as a supported layer or coating (e.g., on a substrate or structured packing) and contacted with carbon dioxide in a flow-by configuration. The carbon dioxide may be provided as substantially pure carbon dioxide or as a component of a mixed gas stream (e.g., air, flue gas, or other process gas), and the contacting may be conducted batchwise or continuously with control of gas flow rate, residence time, humidity, and mixing to achieve a desired extent of conversion. In certain embodiments, contacting is performed in the presence of moisture, including ambient humidity or added water, to facilitate carbonation and formation of hydrated basic carbonates, while in other embodiments contacting is performed under substantially dry conditions. In other embodiments contacting is performed with air, either on the earth surface or in custom-built holders, either under normal conditions or with a fan or other device to increase circulation.

The alkaline earth metal hydroxide may be any hydroxide of an alkaline earth metal (e.g., magnesium, calcium, strontium, barium) capable of reacting with carbon dioxide to form a basic alkaline earth metal carbonate as described herein. In various embodiments, the alkaline earth metal hydroxide comprises magnesium hydroxide (Mg(OH)₂), calcium hydroxide (Ca(OH)₂), or a combination thereof. The alkaline earth metal hydroxide may be provided as a substantially single hydroxide phase or as a mixture including two or more alkaline earth hydroxides, and may further include minor amounts of other constituents (e.g., inert minerals, residual salts, oxides, or carbonates). In some embodiments, the alkaline earth metal hydroxide is derived from hydration of an alkaline earth metal oxide (e.g., MgO and/or CaO), from precipitation from aqueous solution, from reaction with steam, from milling and classification of naturally occurring hydroxide-containing minerals, or from processing of industrial byproducts or alkaline wastes that contain magnesium and/or calcium hydroxide.

The hydroxide may be used as received or may be conditioned prior to use, for example by grinding, milling, sieving, pelletizing, extrusion, granulation, calcination/hydration cycling, or other treatments that adjust particle size distribution, surface area, porosity, bulk density, and mechanical strength.

In certain embodiments, the alkaline earth metal hydroxide comprises Mg(OH)₂ (brucite) as a primary reactive phase. Magnesium hydroxide may be advantageous in some applications due to its ability to form magnesium hydroxycarbonates (e.g., hydromagnesite and artinite) and related basic magnesium carbonate phases under carbonation conditions, including in the presence of moisture. Brucite may be provided as a fine powder to increase reactive surface area and carbonation rate, or as formed bodies (e.g., pellets, granules, extrudates, briquettes, monoliths, or coated structures) to facilitate handling and reduce pressure drop in flow-through contactors. The brucite may be synthetic (e.g., precipitated magnesium hydroxide), derived from hydration of MgO, or obtained from natural sources and processed to a desired purity and morphology. In some embodiments, Mg(OH)₂ is combined with binders or structural additives (e.g., inorganic binders, clays, or other materials).

In other embodiments, the alkaline earth metal hydroxide comprises Ca(OH)₂ (portlandite) as a primary reactive phase. Calcium hydroxide may be advantageous in some applications due to its high reactivity toward carbon dioxide and widespread availability, including from lime hydration processes and industrial sources. Portlandite may likewise be employed in powdered form, as a slurry or suspension, or as shaped solids such as pellets, granules, or extrudates. In some embodiments, portlandite is produced by hydrating CaO obtained from calcination of limestone or other calcium-bearing materials, or is obtained as a commercially available hydrated lime product. As with magnesium hydroxide, calcium hydroxide may be physically conditioned.

In some embodiments, mixtures of brucite and portlandite are employed to balance kinetics, capacity, handling characteristics, and regeneration behavior. For example, a blended hydroxide composition may provide rapid initial uptake attributable to portlandite while enabling formation of magnesium hydroxycarbonate phases that may exhibit favorable cyclic stability under steam regeneration conditions. The alkaline earth metal hydroxide may be used in stoichiometric excess relative to carbon dioxide, near-stoichiometric amounts, or in a controlled-deficit mode.

The alkaline earth metal hydroxide may further be characterized by physical attributes relevant to contacting and regeneration. In various embodiments, the alkaline earth metal hydroxide has a particle size distribution with a D50 of about 0.5 μm to 10 mm (e.g., powders having primary particle sizes of about 0.1 to 100 μm, or granules/pellets having characteristic sizes of about 0.5 to 10 mm). In some embodiments, the alkaline earth metal hydroxide has a BET specific surface area of about 0.5 to 300 m²/g (e.g., about 1 to 200 m²/g). In some embodiments, the alkaline earth metal hydroxide has a total porosity of about 5% to 80% by volume, with an average pore diameter (e.g., BJH) of about 2 nm to 10 μm.

The alkaline earth metal hydroxide may include inherent or added water, including water of hydration and/or free moisture, and the water content may be controlled to promote carbonation while maintaining flowability and avoiding excessive agglomeration. In fixed-bed embodiments, formed bodies may be selected to provide crush strength and attrition resistance, while in fluidized-bed embodiments particles may be selected to provide fluidization stability and manageable elutriation. In slurry embodiments, solids concentration and rheology may be controlled to permit efficient gas/liquid mass transfer and solids recovery. In all cases, the alkaline earth metal hydroxide serves as a recyclable reactant that, after carbonation to a basic alkaline earth metal carbonate and subsequent steam regeneration, is returned to a hydroxide-rich state suitable for further carbon dioxide capture cycles.

In various embodiments, the carbon dioxide contacted with the alkaline earth metal hydroxide is provided as a component of a gas stream rather than as pure carbon dioxide. For example, the carbon dioxide may be present in a mixed gas comprising one or more additional components such as nitrogen, oxygen, water vapor, argon, carbon monoxide, hydrogen, methane or other light hydrocarbons, sulfur oxides (SOₓ), nitrogen oxides (NOₓ), and/or trace contaminants, depending on the source. Illustrative, non-limiting carbon dioxide-containing gas mixtures include flue gas from combustion sources (e.g., boilers, furnaces, turbines), process off-gases from industrial operations (e.g., cement, steel, lime, hydrogen, ammonia, and chemical production), natural gas or biogas processing streams, fermentation off-gas, and ambient air.

In various embodiments, the product formed upon contacting the alkaline earth metal hydroxide with carbon dioxide comprises a basic alkaline earth metal carbonate, meaning a carbonate-containing solid in which the anionic content includes carbonate groups and hydroxide groups, and which may further include water of hydration (e.g., structurally bound water and/or physically retained water). The term “basic” as used herein thus distinguishes such materials from a fully neutral alkaline earth metal carbonate (e.g., MgCO₃ or CaCO₃) by the presence of hydroxide in the solid-phase composition, with optional hydration depending on formation conditions (e.g., humidity, temperature, and residence time). The basic alkaline earth metal carbonate may be present as a substantially single phase or as a multiphase material, for example comprising one or more basic carbonate phases together with residual alkaline earth metal hydroxide and/or neutral carbonate, and the relative proportions of carbonate, hydroxide, and hydration water may vary with extent of carbonation and drying history while remaining within the scope of a basic alkaline earth metal carbonate.

In some embodiments, the basic alkaline earth metal carbonate comprises an alkaline earth metal hydroxycarbonate comprising magnesium, calcium, or a combination thereof. In this context, an “alkaline earth metal hydroxycarbonate” refers to a basic alkaline earth metal carbonate phase in which the alkaline earth cation(s) (e.g., Mg²⁺, Ca²⁺) are associated with both carbonate and hydroxide (and optionally hydration water) in the crystal structure and/or solid composition. Representative hydroxycarbonates include hydromagnesite and artinite as prototypical magnesium-containing examples, as well as calcium-containing and mixed Mg/Ca hydroxycarbonate phases that may form under the selected contacting conditions. Thus, the basic alkaline earth metal carbonate may comprise a magnesium hydroxycarbonate, a calcium hydroxycarbonate, and/or a mixed magnesium/calcium hydroxycarbonate, optionally in combination with other carbonate-containing phases, and may be configured to provide a regenerable intermediate that can be converted back to an alkaline earth metal hydroxide upon steam contacting as described herein.

The method also includes contacting the basic alkaline earth metal carbonate with heated steam to yield a recycled alkaline earth metal hydroxide and a regeneration off-gas stream comprising carbon dioxide. In some embodiments, the basic alkaline earth metal carbonate is regenerated by contacting the basic alkaline earth metal carbonate with heated steam in a reactor, vessel, or other contacting apparatus configured to promote gas/solid interaction. The basic alkaline earth metal carbonate may be provided as a powder, granules, pellets, extrudates, a packed bed, a fluidized bed, or a supported layer (e.g., coated on a substrate), and may be arranged to provide a selected bed depth and void fraction to facilitate steam penetration and removal of evolved gases (i.e., the regeneration off-gas stream). Contacting may be carried out in a flowing system having an inlet and an outlet, in which heated steam is introduced through the inlet and, during the contacting, a regeneration off-gas stream comprising carbon dioxide is withdrawn through the outlet. Flow may be co-current, counter-current, or cross-flow relative to the basic alkaline earth metal carbonate, and may be continuous or semi-batch with periodic solids loading and unloading.

The contacting may be performed under slight positive pressure or near ambient pressure (e.g., 0 to 200 kPa(g), alternatively 0 to 50 kPa(g), or alternatively 1 to 20 kPa(g)), with flow control (e.g., mass flow controllers, valves, blowers) selected to maintain steam delivery and to continuously sweep the contacting zone such that carbon dioxide released from the basic alkaline earth metal carbonate is conveyed out of the apparatus as the regeneration off-gas stream. The contacting may further include agitation, vibration, bed mixing, or fluidization.

In certain embodiments, the step of contacting the basic alkaline earth metal carbonate with heated steam is conducted at a regeneration temperature of 50 to 300° C., alternatively less than or equal to 250° C., alternatively 50 to 150° C., alternatively 80 to 120° C., alternatively 90 to 110° C., alternatively 150 to 250° C., or alternatively 180 to 220° C. The step of contacting the basic alkaline earth metal carbonate with heated steam is performed for a regeneration time of 6 to 96 hours, alternatively 12 to 60 hours, alternatively 24 to 54 hours, alternatively 42 to 60 hours, alternatively 3 to 48 hours, or alternatively 12 to 36 hours. In specific exemplary embodiments, the regeneration temperature is 200° C. and the regeneration time is 48 hours. In alternative exemplary embodiments, the regeneration temperature is 100° C. and the regeneration time is 24 hours.

As used herein, “heated steam” refers to water vapor provided at an elevated enthalpy relative to ambient conditions and delivered to the contacting apparatus as a steam-containing regeneration gas. The heated steam may be generated by vaporizing liquid water (including deionized water, process water, or condensate) in a steam generator, boiler, or evaporator, optionally followed by superheating in a heater, heat exchanger, or inline superheater to reduce entrained liquid droplets and provide a stable vapor-phase feed. In some embodiments, steam is produced by direct injection of water into a heated zone (e.g., onto a heated surface or into a vaporizer), by passage of water through an electrically heated cartridge or coil, by indirect heating with a thermal fluid or waste-heat source, or by flashing pressurized hot water across a pressure-reducing device into a lower-pressure region. The heated steam may be substantially pure water vapor or may be diluted with one or more carrier gases (e.g., nitrogen, air, carbon dioxide, or recycled off-gas) while remaining steam-rich; in either case, the steam may be supplied as saturated steam or superheated steam depending on the heating and delivery conditions. In certain embodiments, the steam supply includes a moisture separator, demister, or condensate trap to limit liquid water carryover, and the steam feed may be conditioned (e.g., filtered or deoxygenated) prior to introduction into the contacting apparatus.

Contacting the basic alkaline earth metal carbonate (e.g., an alkaline earth metal hydroxycarbonate) with heated steam yields a recycled alkaline earth metal hydroxide that is suitable for reuse in another carbon dioxide contacting step. The recycled alkaline earth metal hydroxide may comprise magnesium hydroxide, calcium hydroxide, or a combination thereof, consistent with the alkaline earth metal hydroxides described above, and may be returned to the capture step directly or after optional conditioning (e.g., drying, cooling, sizing, or shaping). In some embodiments, the recycled alkaline earth metal hydroxide differs from a fresh hydroxide feed in that it may retain residual carbonate and/or water (e.g., as surface species or minor phases), may exhibit a modified particle morphology, surface area, and/or porosity due to prior carbonation/regeneration cycling; however, such changes generally do not preclude further carbonation and may be managed by conventional solids handling and conditioning operations.

In various embodiments, contacting the basic alkaline earth metal carbonate with heated steam produces a regeneration off-gas stream comprising carbon dioxide, which carries carbon dioxide released during regeneration out of the contacting apparatus. The regeneration off-gas stream may further comprise steam (water vapor) and entrained water droplets, inert gases, or trace impurities, and may be withdrawn continuously or intermittently (e.g., via an outlet in a flowing system) for subsequent handling, conditioning, and/or storage as described herein.

In certain embodiments, the method further comprises, after producing the recycled alkaline earth metal hydroxide, subsequently contacting at least a portion of the recycled alkaline earth metal hydroxide with carbon dioxide to again yield a basic alkaline earth metal carbonate. Such subsequent contacting may be carried out using any of the carbon dioxide contacting techniques described above for the alkaline earth metal hydroxide, including gas/solid contacting (e.g., fixed bed, moving bed, fluidized bed, or flow-by over a supported layer) and/or gas/liquid contacting (e.g., slurries or suspensions), and may be performed in the same contacting apparatus as an initial capture step or in a separate contacting apparatus. In some embodiments, the recycled alkaline earth metal hydroxide is transferred from a regeneration zone to a capture zone (e.g., by conveying, gravity flow, pneumatic transport, or slurry transfer), optionally after intermediate conditioning such as cooling, drying, humidifying, comminution, sizing, or shaping, and is then exposed to a carbon dioxide-containing gas stream under conditions effective to form carbonate and hydroxide groups (and optionally hydration water) in the resulting basic alkaline earth metal carbonate.

In specific embodiments, the capture and regeneration steps are performed cyclically, such that the method is repeated for at least two cycles and, in certain embodiments, for a plurality of cycles. The cycles may be conducted batchwise with discrete solids charges, semi-continuously, or continuously using circulating solids between a carbonation reactor and a steam regeneration reactor, and may include recycle of solids and/or gases as described herein. In some embodiments, process control parameters (e.g., gas flow rate, steam flow rate, residence time, humidity, and solids inventory) are adjusted between cycles to maintain a desired conversion level and to manage gradual changes in solids properties attributable to cycling, while maintaining production of a regeneration off-gas stream comprising carbon dioxide during regeneration and formation of a basic alkaline earth metal carbonate during subsequent carbonation.

The method may comprise conditioning the regeneration off-gas stream prior to storing, wherein conditioning comprises one or more of compressing, drying, cooling, or purifying the regeneration off-gas stream. For example, the regeneration off-gas stream may be cooled in a condenser or heat exchanger to reduce temperature and to condense at least a portion of water, and condensed water may be separated (e.g., via a knockout drum, demister, or separator) to provide a drier carbon dioxide-containing stream. Drying may additionally or alternatively be performed using one or more desiccant beds, membrane dryers, refrigeration-based dryers, or other dehumidification equipment. Compression may be performed using one or more blowers or compressors (e.g., single-stage or multi-stage with intercooling) to increase pressure for storage, transport, or injection. Purification may include, for example, removal of particulates (e.g., filters), removal or reduction of non-condensable gases or trace contaminants, and/or separation steps configured to increase carbon dioxide concentration relative to other gases that may be present (e.g., carrier gases introduced with steam or co-present gases from the carbon dioxide source), with the particular conditioning train selected based on the intended storage mode and required gas specifications.

In particular embodiments, the method further comprises storing at least a portion of the regeneration off-gas stream in a storage vessel. The storage vessel may comprise, for example, a pressurized tank, cylinder bank, pipeline line-pack volume, buffer vessel, or other containment suitable for holding a carbon dioxide-containing gas stream for subsequent use, transport, or disposition. In some embodiments, storage is performed continuously as the regeneration off-gas stream is produced, while in other embodiments the regeneration off-gas stream is accumulated intermittently (e.g., during regeneration periods) and stored to decouple regeneration operation from downstream handling. The stored portion may comprise a majority of the regeneration off-gas stream or a selected split stream, with any remaining portion optionally vented, recycled, further processed, or directed to an alternate destination.

In some embodiments, storing the portion of the regeneration off-gas stream comprises injecting at least a portion of the regeneration off-gas stream into a subsurface geological formation for sequestration. The regeneration off-gas stream may be conditioned as described above prior to injection, for example by dewatering, compressing, and/or purifying to meet pipeline and/or injection requirements. Injection may be performed into any suitable subsurface formation, including without limitation saline aquifers, depleted oil and gas reservoirs, unmineable coal seams, basalt formations, or other geological formations capable of receiving and retaining carbon dioxide. In such embodiments, the storage vessel may comprise or be fluidly coupled to intermediate containment and/or transport infrastructure (e.g., buffer tanks, pipelines, or transport containers) used to deliver the regeneration off-gas stream to an injection site.

A method of regenerating an alkaline earth metal hydroxycarbonate is also discussed herein. In various embodiments, the method comprises contacting an alkaline earth metal hydroxycarbonate with heated steam to yield a recycled alkaline earth metal hydroxide and a regeneration off-gas stream comprising carbon dioxide, wherein the heated steam is at a regeneration temperature of less than or equal to 250° C., alternatively less than or equal to 220° C. and wherein the alkaline earth metal hydroxycarbonate comprises magnesium, calcium, or a combination thereof. The contacting may be performed in a flowing system comprising an inlet and an outlet, in which heated steam is introduced through the inlet and the regeneration off-gas stream is withdrawn through the outlet during said contacting. In some embodiments, the alkaline earth metal hydroxycarbonate comprises hydromagnesite, artinite, or a mixture of hydroxycarbonate phases, and the recycled alkaline earth metal hydroxide comprises magnesium hydroxide, calcium hydroxide, or a combination thereof suitable for subsequent use in carbon dioxide capture as described herein. The foregoing descriptions regarding heated steam, contacting configurations, operating parameters, off-gas handling, and optional conditioning and storage are applicable to the regeneration method described in this paragraph.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A method of capturing and releasing carbon dioxide, the method comprising:
contacting an alkaline earth metal hydroxide with carbon dioxide to yield a basic alkaline earth metal carbonate; and
contacting the basic alkaline earth metal carbonate with heated steam to yield a recycled alkaline earth metal hydroxide and a regeneration off-gas stream comprising carbon dioxide; and
wherein the basic alkaline earth metal carbonate comprises carbonate and hydroxide groups and optionally water of hydration.

2. The method of claim 1, wherein, during the step of contacting the basic alkaline earth metal carbonate with heated steam, the heated steam is at a regeneration temperature of 50 to 300° C.

3. The method of claim 2, wherein, during the step of contacting the basic alkaline earth metal carbonate with heated steam, the heated steam is at a regeneration temperature of 80 to 120° C.

4. The method of claim 3, wherein the step of contacting the basic alkaline earth metal carbonate with heated steam is performed for a regeneration time of 6 to 96 hours.

5. The method of claim 2, wherein, during the step of contacting the basic alkaline earth metal carbonate with heated steam, the heated steam is at a regeneration temperature of 180 to 220° C.

6. The method of claim 5, wherein the step of contacting the basic alkaline earth metal carbonate with heated steam is performed for a regeneration time of 3 to 48 hours.

7. The method of claim 1, wherein the step of contacting the basic alkaline earth metal carbonate with heated steam is performed in a flowing system comprising an inlet and an outlet, and wherein the heated steam is introduced through the inlet and the regeneration off-gas stream is withdrawn through the outlet during said contacting.

8. The method of claim 1, wherein the method further comprises subsequently contacting the recycled alkaline earth metal hydroxide with carbon dioxide to yield a basic alkaline earth metal carbonate.

9. The method of claim 8, wherein the method is repeated for at least two cycles.

10. The method of claim 1, wherein the method further comprises storing at least a portion of the regeneration off-gas stream in a storage vessel.

11. The method of claim 10, wherein the method further comprises conditioning the regeneration off-gas stream prior to storing, wherein conditioning comprises one or more of compressing, drying, cooling, or purifying the regeneration off-gas stream.

12. The method of claim 10, wherein storing the portion of the regeneration off-gas stream comprises injecting at least a portion of the regeneration off-gas stream into a subsurface geological formation.

13. The method of claim 1, wherein the alkaline earth metal hydroxide comprises magnesium hydroxide, calcium hydroxide, or a combination thereof.

14. The method of claim 13, wherein the alkaline earth metal hydroxide comprises magnesium hydroxide.

15. The method of claim 13, wherein the alkaline earth metal hydroxide comprises calcium hydroxide.

16. The method of claim 1, wherein the basic alkaline earth metal carbonate comprises an alkaline earth metal hydroxycarbonate comprising magnesium, calcium, or a combination thereof.

17. The method of claim 16, wherein the alkaline earth metal hydroxycarbonate comprises hydromagnesite.

18. The method of claim 16, wherein the alkaline earth metal hydroxycarbonate comprises artinite.

19. A method of regenerating an alkaline earth metal hydroxycarbonate, the method comprising:
contacting the alkaline earth metal hydroxycarbonate with heated steam to yield a recycled alkaline earth metal hydroxide and a regeneration off-gas stream comprising carbon dioxide;
wherein the heated steam is at a regeneration temperature of less than or equal to 250° C.; and
wherein the alkaline earth metal hydroxycarbonate comprises magnesium, calcium, or a combination thereof.

20. The method of claim 19, wherein the step of contacting the alkaline earth metal hydroxycarbonate with heated steam is performed in a flowing system comprising an inlet and an outlet, and wherein the heated steam is introduced through the inlet and the regeneration off-gas stream is withdrawn through the outlet during said contacting.
